(19) United States
(12) Patent Application Publication
(10) Pub. No.: US 2024/0169035 A1
(43) Pub. Date: May 23, 2024

(54) RESTRICTIONS FOR AUTONOMOUS VEHICLE SOFTWARE RELEASES AT DEPLOYMENT, AT LAUNCH, AND AT RUNTIME

(71) Applicant: GM Cruise Holdings LLC, San Francisco, CA (US)

(72) Inventors: Collin Mulliner, Stamford, CT (US); Graziano Misuraca, New York, NY (US); George Albertson, Oakland, CA (US); Liam Staskawicz, Berkeley, CA (US)

(73) Assignee: GM Cruise Holdings LLC, San Francisco, CA (US)

(21) Appl. No.: 18/057,526

(22) Filed: Nov. 21, 2022

(51) Int. Cl. G06F 21/12; B60W 50/06; B60W 50/14; B60W 60/00; G06F 8/65; G06F 21/62

(52) U.S. Cl. CPC G06F 21/12; B60W 50/06; B60W 50/14; B60W 60/001; G06F 8/65; G06F 21/629; G06F 2221/0704

(57) ABSTRACT

Restrictions at launch-time can ensure that specific types of AV stacks are launched and ensure the software release is launched only during certain times. Restrictions at runtime can ensure that certain operations are prohibited while the software release is running on the autonomous vehicle. Enforcing restrictions at launch-time and runtime is not trivial. A schema can be used to encode the restrictions. Restrictions may be included in a manifest of the software release. The manifest having the restrictions can be cryptographically signed. Components can be implemented to verify and enforce these restrictions on the AV. As a result, more kinds of restrictions and more complex restrictions can be applied for software releases for the AV.

### BACKGROUND

### 1. Technical Field

The present disclosure generally relates to autonomous vehicles and, more specifically, to enforcing restrictions for autonomous vehicle software releases.

### 2. Introduction

Autonomous vehicles, also known as self-driving cars, and driverless vehicles, may be vehicles that use multiple sensors to sense the environment and move without human input. Automation technology in the autonomous vehicles may enable the vehicles to drive on roadways and to accurately and quickly perceive the vehicle's environment, including obstacles, signs, and traffic lights. Autonomous technology may utilize geographical information and semantic objects (such as parking spots, lane boundaries, intersections, crosswalks, stop signs, traffic lights) for facilitating the vehicles in making driving decisions. The vehicles can be used to pick up passengers and drive the passengers to selected destinations. The vehicles can also be used to pick up packages and/or other goods and deliver the packages and/or goods to selected destinations.

### BRIEF DESCRIPTION OF THE DRAWINGS

The various advantages and features of the present technology will become apparent by reference to specific implementations illustrated in the appended drawings. A person of ordinary skill in the art will understand that these drawings show only some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates a software release deployment system that can enforce restrictions for the software releases being deployed to a plurality of autonomous vehicles, according to some aspects of the disclosed technology;

FIG. 2 illustrates an exemplary data structure of a descriptor for a software release that has a cryptographically signed signature, according to some aspects of the disclosed technology;

FIG. 3 illustrates different types of restrictions which can be applied at/before deployment, at/before launch, and at/during runtime, according to some aspects of the disclosed technology;

FIG. 4 is an application flow diagram illustrating enforcement of the different types of restrictions as illustrated in FIG. 3, according to some aspects of the disclosed technology;

FIG. 5 is a flow diagram illustrating a computer-implemented method for respecting restrictions on a software release for deployment on one or more processors of an autonomous vehicle, according to some aspects of the disclosed technology;

FIG. 6 illustrates an example system environment that may be used to facilitate autonomous vehicles (AV) operations, according to some aspects of the disclosed technology; and

FIG. 7 illustrates an example processor-based system with which some aspects of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

### Overview

AVs can provide many benefits. For instance, AVs may have the potential to transform urban living by offering opportunity for efficient, accessible, and affordable transportation. An AV may be equipped with various sensors to sense an environment surrounding the AV and collect information (e.g., sensor data) to assist the AV in making driving decisions. To that end, the collected information or sensor data may be processed and analyzed to determine a perception of the AV's surroundings, extract information related to navigation, and predict future motions of the AV and/or other traveling agents in the AV's vicinity. The predictions may be used to plan a path for the AV (e.g., from a starting position to a destination). As part of planning, the AV may access map information and localize itself based on location information (e.g., from location sensors) and the map information. Subsequently, instructions can be sent to a controller to control the AV (e.g., for steering, accelerating, decelerating, braking, etc.) according to the planned path.

The operations of perception, prediction, planning, and control at an AV may be implemented using a combination of hardware and software components. For instance, an AV stack or AV compute process performing the perception, prediction, planning, and control may be implemented as software code or firmware code. The AV stack or AV compute process (the software and/or firmware code) may be executed on processor(s) (e.g., general processors, central processors (CPUs), graphical processors (GPUs), digital signal processors (DSPs), ASIC, etc.) and/or any other hardware processing components on the AV. Additionally, the AV stack or AV compute process may communicate with various hardware components (e.g., on-board sensors and control system of the AV) and/or with an AV infrastructure over a network. The AV stack can include a foundational compute process on which additional applications or software releases can be run.

Software releases for the AV stack may be routinely updated by developers of the software, and may be distributed to a plurality of AVs at designated times. Software releases can be deployed or sent to autonomous vehicles. Once deployed, the software releases can be launched with the AV stack upon boot-up of the AV stack. Once launched, the software release can run with the AV stack.

Because the software can impact performance of the AVs, the software releases are distributed securely to the AVs using cryptographic signatures. The cryptographic signatures can allow the AVs to authenticate the source of the software release and to verify the integrity of the software release through the use of hashes. Cryptographic signatures can rely on asymmetric cryptography.

In some cases, it may be beneficial to include restrictions for the software release, so that the developer can better control and restrict the deployment, launch, and runtime operation of the software release. Restrictions can be conditions or constraints that be specified based on a schema and can be enforced by various components of the autonomous vehicle that is receiving the software release. Restrictions can be based on one or more of: characteristics of the AV, operations of the AV, and external parameters.

Restrictions at launch-time can ensure that specific types of AV stacks are launched and ensure the software release is launched only during certain times. Restrictions at runtime can ensure that certain operations are prohibited while the software release is running on the autonomous vehicle. Enforcing restrictions at launch-time and runtime is not trivial. A schema can be used to encode the restrictions. Restrictions may be included in a manifest of the software release. The manifest having the restrictions can be cryptographically signed. Components can be implemented to verify and enforce these restrictions on the AV. As a result, more kinds of restrictions and more complex restrictions can be applied for software releases for the AV.

Exemplary Software Release Deployment System

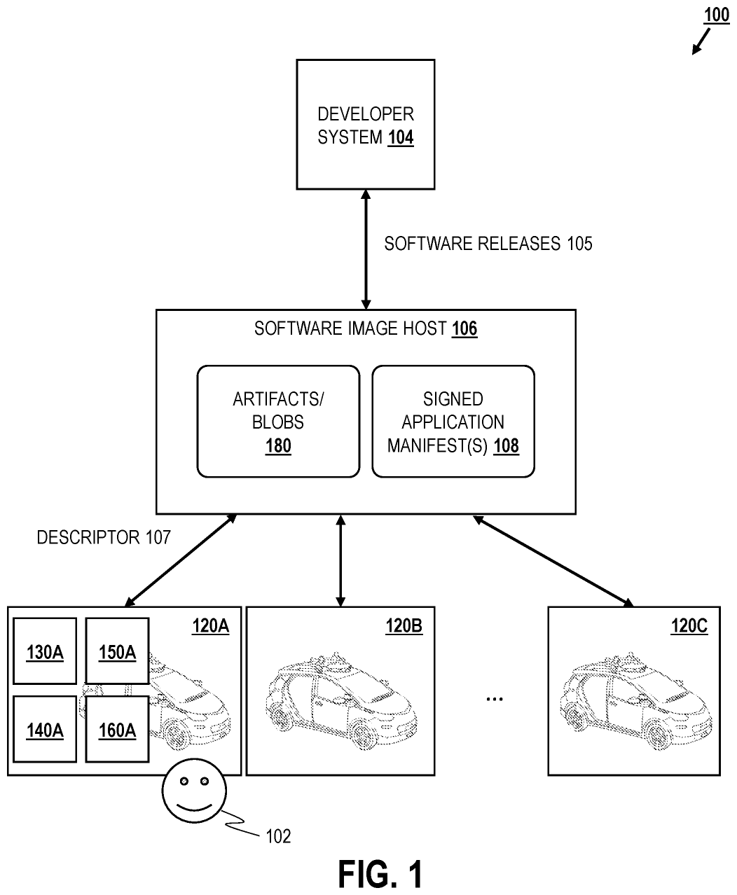

FIG. 1 illustrates a software release deployment system 100 that can enforce restrictions for the software releases being deployed to a plurality of autonomous vehicles, according to some aspects of the disclosed technology. The system 100 includes developer system 104, software image host 106, and a plurality of AVs 120. While three AVs are shown as AV 120A, 120B, and 120C as examples). AV 120A may have an associated user, such as a rider in AV 120A.

Developer system 104 may include components that allow software developers to version control and test different versions of software source code. One example of a developer system may implement continuous integration (CI) of software applications. Developer system 104 may also include a build system that compiles software source code into executable binary code files referred to software releases. Software releases may have different versions based on different versions of the code.

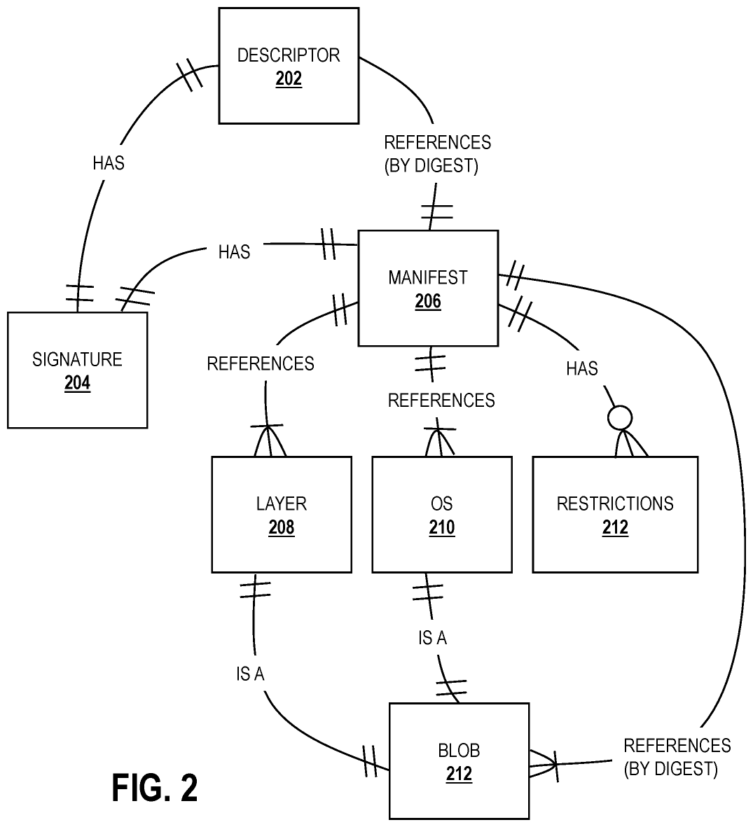

Software releases 105 (including artifacts that support the software release) can be sent from developer system 104 to software image host 106. Software image host 106 may be a repository for storing software releases and/or different software release versions. For instance, software image host 106 may be a data lake storage, which can store artifacts or blobs 180 of software to run different software releases. The software image host 106 or another component in system 100 (not shown) may generate and store cryptographically signed application manifest(s) 108 corresponding to the software releases. An exemplary data structure for a descriptor that has the cryptographically signed application manifest(s) 108 is illustrated in greater detail in FIG. 2. The cryptographically signed application manifest(s) 108 allows AVs 120 to authenticate the source of a given software release, to check the integrity of the given software release. Moreover, the cryptographically signed application manifest(s) 108 can include one or more restrictions for the given software release.

As an illustration for other AVs, AV 120A may include a security component 130A, an entry node 140A, a launcher 150A, and AV software 160A. AV software 160 may include the software release to be deployed to AV 120A. Other AVs may include same/similar components.

AV 120A may request signed application manifest(s) 108 corresponding to a software release in the form of a cryptographic signature or a descriptor having the signature. The signature or a descriptor having the signature may be provided to AV 120A. Security component 130A can verify the signature. Security component 130A may locate the artifacts referenced in the manifest for the software release, and retrieve the artifacts from software image host 106. Additionally, security component 130A can extract restrictions from the manifest. A first subset of restrictions (e.g., before deployment restrictions) can be verified by security component 130. The security component 130A, upon verifying the first subset of restrictions, may deploy or provide the software release to entry node 140A of the AV 120A. Security component 130A may pass the extracted restrictions to entry node 140A.

Entry node 140A of AV 120A may receive restrictions or a subset of restrictions (e.g., launch-time restrictions) extracted from the manifest from security component 130A. Working together with launcher 150A, a second subset of restrictions can be verified at launch-time. Such restrictions may impose conditions or constraints before the AV stack (on which the software release is to be run) is launched on the AV 120A.

For a third subset of restrictions (e.g., runtime restrictions), entry node 140A and launcher 150A may build a configuration based on the third subset of restrictions, which encodes the conditions or constraints during runtime of the software release. The conditions or constraints may be defined as a set of allowed or disallowed operations during runtime of the software release

Launcher 150A may provide the generated configuration to AV software 160A. During runtime of AV software 160A (which may have the software release or is the software release itself), certain operation(s) of the AV 120A may be requested, in some cases, by user 102. Such operations may be verified against the configuration by AV software 160. If the operation is disallowed, then user 102 may be notified of a violation of a restriction.

Exemplary Data Structure of Descriptor Having a Cryptographically Signed Manifest

FIG. 2 illustrates an exemplary data structure of a descriptor for a software release that has a cryptographically signed signature, according to some aspects of the disclosed technology. The descriptor 202 has cryptographically signed signature 204. The signature 204 has the manifest 206. The manifest 206 can reference layer 208 (e.g., layer of the AV stack). The manifest 206 can reference operating system (OS) 210. Layer 208 and OS 210 may be artifacts or blobs that support running the software release. Layer 208 and operating system 210 may be blobs stored on software image host 106 of FIG. 1. Hash digest of each blob (e.g., layer 208 and OS 210 may be included in manifest 206. Additionally, manifest 206 can include one or more restrictions 212. The manifest 206 is cryptographically signed using methods known to the skilled person in the art to form the signature 204.

Exemplary Restrictions and when they can be Enforced

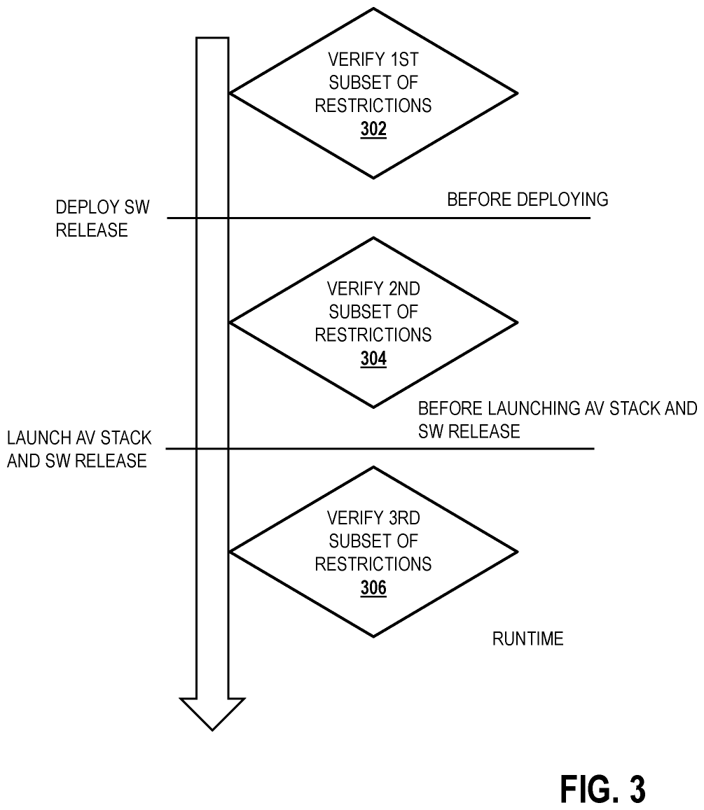

The restrictions can be extracted from the cryptographically signed manifest for a given software release. Different kinds of restrictions, some with different levels of complexity and objectives, can be enforced with a software release. Also, restrictions can be applied at different times: at (or before) deployment, at (or before) launch, and at (or during) runtime of the software release. Some restrictions may be defined as a whitelist, blacklist, or greylist. Some restrictions may be defined as one or more conditions that allow the software release to be deployed, launched, or run. Some restrictions may be defined as one or more conditions that disallow the software release to be deployed, launched, or run. FIG. 3 illustrates different types of restrictions which can be applied at/before deployment, at/before launch, and at/during runtime, according to some aspects of the disclosed technology. A given restriction can be applied one or more times. A combination of different kinds of restrictions can be applied at a given time.

In 302, a first subset of restrictions in the cryptographically signed manifest can be applied at/before deployment. At this time, certain restrictions aiming to verify condition/constraints that are gating factors for deployment can be applied. Gating factors may include identity of the AV, identity of a fleet in which the AV belongs, location of the AV, current time, etc.

In 304, a second subset of restrictions in the cryptographically signed manifest can be applied at/before launching the AV stack and/or the software release. At this time, certain restrictions aiming to verify conditions/constraints of the AV stack or other information can be applied. For instance, conditions/constraints may be applied to the type of AV stack, the version of AV stack, availability of certain components of the AV stack, location of the AV, current time, etc.

In 306, a third subset of restrictions in the cryptographically signed manifest can be applied at/during runtime of the software release. At this time, certain restrictions aiming to verify conditions/constraints on the operations, driving mode, or state of the AV may be applied. For instance, conditions/constraints may be applied to whether an AV is allowed to perform a certain operation, or change to a different driving mode, or be in a degraded state of the AV. In some instances, conditions/constraints may be applied to verify against a current time and a current location of the AV.

Restrictions can be specified in a data interchange format having attribute-value (or key-value) pairs and arrays/lists. One exemplary format is JavaScript Object Notation (JSON). Attribute-value pairs can define different restrictions, or conditions/constraints to be applied.

Different versions of restrictions schema can be defined and supported. By defining new versions of the schema with new sets of restrictions and modifying components of the AV to support the new sets of restrictions, the software deployment system can be made flexible to accommodate new types of restrictions.

An exemplary restrictions schema can be defined as follows:

```
  “restrictions”: {
    “vins”: [“vin1”],
    “not-before”: “epoch time int”,
    “not-after”: “epoch time int”,
    “runtime_restrictions”: {
      “schema_version”: “v0.1.0”,
      “calibration_only”: false,
      “may_engage_driverless”: true,
    }
  “fleets”: [“delta”]
}
```

In some cases, a restriction is a static restriction, which means that static information (information that does not change over time) is checked against a condition/constraint to determine whether a restriction applies or not. Static restrictions can be applied at one or more times illustrated in FIG. 3. Examples of a static restriction includes checking for specific vehicle identification numbers (VINs.), or a fleet to which the AV belongs (though in some cases fleet membership can change over time).

A VIN restriction can be applied at any one of the times illustrated in FIG. 3. For instance, the VIN restriction can allow a software release to be deployed or launched on only a certain set of VINs. The set of VINs can be defined in the value of the attribute-value pair with a “vins” attribute. A component on the AV, e.g., security component 130A of the AV 120A in FIG. 1, with access to the AV's VIN can verify the VIN restriction. If the AV's VIN doesn't match any one of the VINs, then the software release is not deployed or launched.

In some embodiments, the AV may receive a restriction receiving a restriction specifying an authorized vehicle identification number (or a list of authorized vehicle identification numbers), wherein the restriction is extracted from the cryptographically signed manifest. To enforce the restriction, the AV may verify whether a vehicle identification number of the autonomous vehicle matches the authorized vehicle identification number (or is in the list of authorized vehicle identification numbers). If the vehicle identification number of the autonomous vehicle matches the authorized vehicle identification number, the software release may be deployed or launched on the autonomous vehicle. Otherwise (if the vehicle identification number of the autonomous vehicle does not match the authorized vehicle identification number), the software release may be prevented from being deployed or launched on the autonomous vehicle. If the vehicle identification number of the autonomous vehicle is in the list of authorized vehicle identification numbers, the software release may be deployed or launched on the autonomous vehicle. Otherwise (if the vehicle identification number of the autonomous vehicle is not in the list of authorized vehicle identification numbers), the software release may be prevented from being deployed or launched on the autonomous vehicle.

Similar to the VIN restriction, a fleet restriction can be applied at any one of the times illustrated in FIG. 3. For instance, the fleet restriction can allow a software release to be deployed or launched on only a certain set of fleets. The set of fleets can be defined in the value of the attribute-value pair with a “fleets” attribute. A component on the AV, e.g., security component 130A of the AV 120A in FIG. 1, with access to the AV's VIN can query a fleet management system with the AV's VIN to determine which fleet the AV belongs to, and verify the fleet restriction. If the AV's fleet doesn't match any one of the fleets, then the software release is not deployed or launched.

In some embodiments, the AV may receive a restriction specifying one or more authorized fleets, wherein the restriction is extracted from the cryptographically signed manifest. To enforce the restriction, the AV may determine a fleet to which the autonomous vehicle belongs, and may verify whether the fleet matches at least one of the one or more authorized fleets specified in the restriction. If the fleet matches the authorized fleet, deploying or launching the software release on the autonomous vehicle. Otherwise (if the fleet does not match the authorized fleet), preventing the software release from being deployed or launched on the autonomous vehicle.

In some cases, a restriction is a dynamic restriction, which means that dynamic information (information that does change over time) is checked against a condition/constraint to determine whether a restriction applies or not. Dynamic restrictions can be applied at one or more times illustrated in FIG. 3.

One example of a dynamic restriction is a time-related restriction. Time-related restrictions can allow a software release to be deployed or launched during a certain time period, after a certain time, or before a certain time. For instance, a certain time period restriction can be defined in the values of the attribute-value pairs with “not-before” and “not-after” attributes. A component of the AV can check a current time against the time-related restrictions, and assess if the software release should be deployed, or launched. It is also possible for the AV software to check a current time against the time-related restrictions during runtime to determine whether to continue running the AV software or continue with AV operation.

Another example of a dynamic restriction is a location-related restriction. Location-related restrictions can allow a software release to be deployed or launched if a current location of the AV meets one or more conditions or constraints. A component of the AV can check a current location against the location-related restriction, and assess if the software release should be deployed or launched. For instance, a location-related restriction may only allow a software release to be deployed or launched if an AV is within a vicinity of a launch facility or maintenance facility of the AV. It is also possible for the AV software to check a current location of the AV against the location-related restrictions during runtime to determine whether to continue running the AV software, continue with AV operation, or change plan of the AV to avoid violating the location-related restriction. For instance, a location-related restriction may only allow a software release to be run while an AV is located in a geofenced area.

In some embodiments, the AV may receive a restriction specifying a not-before time before which deployment or launch of the software release is not allowed, wherein the restriction is extracted from a cryptographically signed manifest. The AV may verify whether a current time is before the not-before time. If the current time is before the not-before time, the software release is prevented from being deployed or launched on the autonomous vehicle.

In some embodiments, the AV may receive a restriction specifying a not-after time after which deployment or launch of the software release is not allowed, wherein the restriction is extracted from a cryptographically signed manifest. The AV may verify whether a current time is after the not-after time. If the current time is after the not-after time, the software release is prevented from being deployed or launched on the autonomous vehicle.

In some embodiments, the AV may receive a restriction specifying a period of time during which deployment of the software release is allowed, wherein the restriction is extracted from a cryptographically signed manifest. The AV may verify whether a current time is within the period of time. If the current time is not within the period of time, the software release is prevented from being deployed or launched on the autonomous vehicle.

In some cases, during runtime, the AV software may periodically check a current time against a time-related restriction. If the time-related restriction is violated, the AV software may notify the violation of the restriction to a user. In some cases, if the time-related restriction is violated, the AV software may be aborted or uninstalled. In some cases, if the time-related restriction is violated, the AV software may roll back to a previous version of the software release. In some cases, if the time-related restriction is violated, the AV software may be allowed to run until the AV reaches a safe stopped location and ceases operation. In some cases, if the time-related restriction is violated, the AV may be allowed to operate only in a degraded state.

In some cases, a restriction is a launch-time restriction, which means that the restriction may check against a condition/constraint before the software release is launched on the AV stack, or before the AV stack and the software release are launched on the AV, or before the AV stack (if the software release are the software portion of the AV stack) is launched on the AV. Launch-time can be associated with boot-up of the AV stack, e.g., at a beginning of a shift for an AV, when an AV stack is being reset or rebooted, when there is a change in the AV stack to be launched, etc. Launch-time may occur a multiple times a day, or upon certain changes in the AV stack that may cause the AV stack to be re-launched. Examples of launch-time restrictions may include time-related restrictions, location-related restrictions, and conditions on the AV stack (e.g., type, version, specific layers, etc.). Launch-time restrictions may be particularly beneficial for restricting on conditions on the AV stack such that the software release is only launched on a specific AV stack. A component of the AV can check information about the AV stack that is already launched or about to be launched, against a launch-time restriction, and assess if the software release should be launched with the AV stack. For instance, a launch-time restriction may require that that a software release is only launched on a limited-purpose calibration stack (e.g., restriction can be defined in a restriction schema as true/false in the value of the attribute-value pairs for the “calibration only” attribute). Another launch-time restriction may require that a software release is only launched on an on-road AV stack. Yet another launch-time restriction may require a software release is only launched on an AV stack with a certain version or above. Yet another launch-time restriction may require a software release is only launched on an AV stack with a specific set of layers. A component of the AV can check a vehicle stack type value (or other characteristics such as a vehicle stack version, or set of layers) for a given AV stack of the AV to determine whether the software release can be launched with the given AV stack.

In some embodiments, the one or more runtime restrictions comprise a restriction to ensure that the software release is only deployed on a certain type of autonomous vehicle stack. An AV can cause the certain type autonomous vehicle stack to be launched or booted up before launching the software release on the certain type of autonomous vehicle stack. In some cases, the certain type of autonomous vehicle stack may be a limited-purpose calibration stack (to ensure the software release to be used for AV calibration purposes). In some cases, the certain type of autonomous vehicle stack may be an on-road autonomous vehicle stack (to ensure that the software release that ready for on-road driving is used with an on-road AV stack).

In some cases, a restriction is a runtime restriction, which means that the restriction may check against a condition/constraint during runtime of the software release (including a time when the software release begins to run). Runtime of the software release means that the software release is already running and operating on the AV. Restrictions are particularly beneficial in case that certain operations of the AV, modes of the AV, and/or states of the AV are to be prohibited during the runtime of the software release. In some cases, runtime restrictions can include location-related restrictions and/or time-related restrictions.

Implementing runtime restrictions is not trivial, since the restrictions are to be applied while the software release is running. The information about restrictions can be translated into information that can be processed and verified by AV software during runtime. Verifying restrictions may be performed and/or triggered at appropriate times such that it is possible to ensure violations of the restrictions can be detected in a timely fashion.

One approach to enforcing runtime restrictions is to create a configuration based on the restrictions to be applied at runtime. The configuration can be checked or verified by the AV software, at determined times during runtime, or periodically during runtime, to determine if any restrictions have been violated. In some cases, a verification with the configuration may be triggered upon a request of the AV to perform an operation or some other suitable event. A configuration may be a configuration file that includes a set of variables and corresponding values. One exemplary variable is may engage driverless, and a corresponding value may be FALSE. The configuration file may include text such as “may engage driverless=FALSE”. When the AV software is running, checks can be performed with the configuration file, e.g., checking the value for may engage driverless, to determine whether the AV may enter into autonomous mode.

The AV software may be written or designed to operate in accordance with the configuration. The AV software may be aware of the restrictions, and may be written or designed to check the values of the variables in the configuration file before operations are performed, to ensure that the runtime restrictions are not violated by planned operations of the AV software. For instance, the AV software may, before taking on a new operational assignment (e.g., a trip or a route to a new destination), check geographical information corresponding to the new operational assignment against runtime restrictions in the configuration to ensure that the new operational assignment does not violate any runtime restrictions (e.g., verify that the operational assignment does not take the AV outside a geofenced area).

If a runtime restriction is violated, there may be different kinds of responses to the detected violation. For instance, a user may be notified of the violation. In another instance, a request to perform an operation may be rejected. In yet another instance, the AV software may cease to run. In some cases, the AV may degrade to a different state where a requested operation can be performed.

One exemplary restriction that can be applied by the AV software is to disallow driverless operation during runtime. Suppose during runtime of AV software (e.g., AV is driving on the road), that a user/rider of the AV would like to no longer be holding the steering wheel or be ready to take over, and wants to allow the AV to engage in driverless operation. If there is a restriction that disallows driverless operation, a configuration can be verified in response to a request being made by the user to engage in driverless operation. The driverless operation request can be rejected, and the user/rider may be informed accordingly, with a visual and/or audio message such as “You may not engage in driverless operation, please keep your hands on the steering wheel”.

Another exemplary restriction that can be applied by the AV software is to disallow passenger(s) in the AV during runtime. If there is a restriction that disallows passenger(s), a configuration can be verified by the AV software in response to a request to, e.g., add an operational assignment to pick up a passenger, open a door to allow a passenger to enter the AV, etc. The request can be rejected if approving the request would otherwise cause a passenger to enter into the AV.

Various operations of the AV may trigger a configuration to be verified. Various operations can be restricted from being performed by runtime restrictions. Examples of such operations include, but are not limited to:
the operation is related to engaging in driverless operation (e.g., restriction in a restriction schema can be defined as true/false in the value of the attribute-value pairs for the “may engage driverless” attribute);
   during runtime of the software release, the “may engage driverless” restriction may determine whether the software release may operate in unsupervised driverless mode (if value is true), or whether the software release may operate in only supervised driving mode (if value is false); and
   production-signed software release that is not an official release by a release team may have “may engage driverless” value set as false;
the operation is related to entering a new operational design domain (ODD), which is defined as a set of conditions that an AV is to be operating in;
the operation is related to crossing a perimeter of a geofenced area;
the operation is related to leaving a geofenced area;
the operation is related to driving on a road having a certain grade;
the operation is related to performing a driving maneuver (e.g., a U-turn, driving at a certain speed, driving in reverse, parallel parking, maneuvering around a Double-Parked Vehicle (DPV));
the operation is related to the autonomous vehicle taking on a new operational assignment, e.g., the autonomous vehicle receives and accepts a new operational assignment to complete a new trip or route, where operational assignments can include returning to a maintenance facility, picking up a passenger, dropping off a passenger, picking up a delivery cargo, dropping off a delivery cargo;
the operation is related to allowing a passenger to enter a cabin of the vehicle (e.g., opening a door to allow the passenger to enter);
the operation is related to driving on a certain types of roads, such as freeway, highway, unpaved roads, unmarked roads, etc.;
the operation is related to driving or accelerating over a specified threshold;
the operation is related to driving in inclement weather; and
the operation is related to driving in the dark.

When there is a set of compatible restrictions, the restrictions can be enforced as if the restrictions are linked by AND operations. This means that all conditions corresponding to the restrictions are met for the software to be deployed, launched, or run.

In some embodiments, there is a set of incompatible restrictions. Restrictions may be incompatible if the restrictions may trigger competing, or conflicting responses if the restrictions are violated. Priorities may help to prioritize certain restrictions over others that are incompatible with each other. Accordingly, restrictions may have corresponding one or more priorities. Restrictions may have different levels of priorities such that restrictions can be ranked from highest priority to lowest priority. If multiple restrictions having different levels of priority (or priority values) may trigger incompatible/conflicting responses and conditions for the restrictions have all been met, the restriction with a higher priority (or higher priority value) may win. The response corresponding to the restriction with the higher level of priority would be performed, and the response corresponding to other restrictions may not be performed. A restriction having a higher priority value may override another restriction having a lower priority value.

In some embodiments, restrictions may be arranged in a logical hierarchy of conditions, constraints, or restrictions. Such a logical hierarchy of restrictions may provide for more complex logic design in the restriction schema. For instance, restrictions may be logically combined to define a complex set of conditions to verify. Leaves of a logical hierarchy or tree of restrictions may correspond to different responses to be performed.

In some embodiments, the value of a restriction may include an array of conditions where a certain number of conditions out of a total number of conditions are to be met.

In some embodiments, certain restrictions in the signed manifest may override other restrictions being applied by a fleet management system managing a fleet of AVs.

Exemplary Application Flow for Enforcing Restrictions

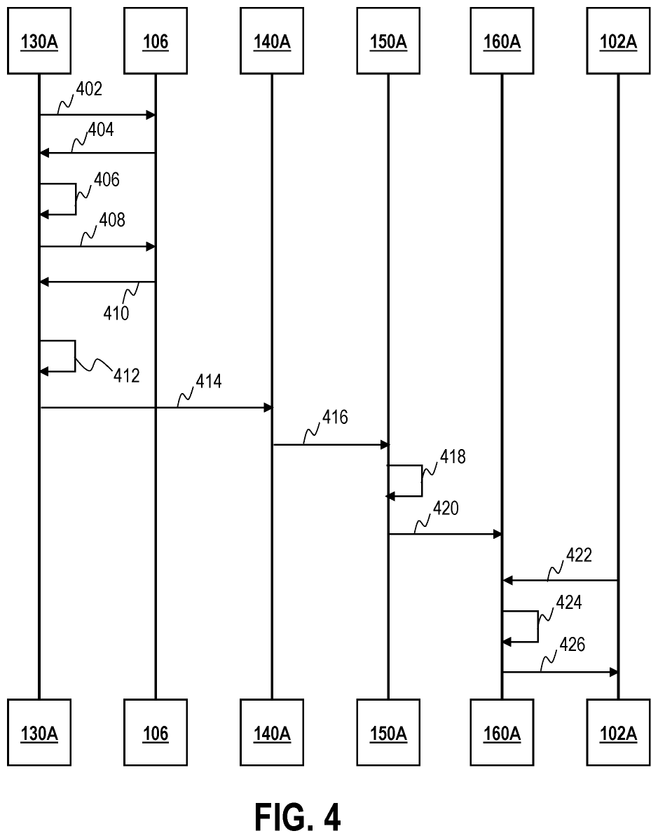

FIG. 4 is an application flow diagram illustrating enforcement of the different types of restrictions as illustrated in FIG. 3, according to some aspects of the disclosed technology.

In 402, security component 130A can request a cryptographically signed manifest of a software release from software image host 106. The cryptographically signed manifest may include a hash digest of each artifacts, and one or more restrictions. An example of the manifest is shown in FIG. 2. Detailed examples of restrictions are described with FIG. 3.

In 404, software image host 106 can provide the cryptographically signed manifest to security component 130A.

In 406, security component 130A can validate or verify the cryptographically signed manifest, and extract information about the artifacts (e.g., metadata about the artifacts).

In 408, security component 130A can retrieve artifacts (e.g., blobs such as layer and OS) from the software image host 106.

In 410, software image host 106 can provide the artifacts to the security component 130A.

In 412, software image host 106 may verify a first subset of restrictions, e.g., before deployment restrictions, prior to deploying the software release.

In 414, if the first subset of restrictions are not violated, the security component 130A can deploy or send the artifacts along with the restrictions (or some of the restrictions) to entry node 140A.

In 416, entry node 140 and launcher 150 may cooperate to apply a second subset of restrictions (e.g., launch-time restrictions) prior to launching the software release onto the AV.

In 418, launcher 150 may generate a configuration based on a third subset of restrictions (e.g., runtime restrictions).

In 420, the launcher 150 may provide the generated configuration to AV software 160A.

In some cases, launcher 150 may generate a configuration, and AV software 160A may generate a derivative of the configuration that can be processed and verified by the AV software 160A. For instance, launcher 150 may include runtime restrictions in the configuration, and provide the configuration to the AV software 160A. The AV software 160A may translate the restrictions into variables and corresponding values that can be checked or verified by AV software 160A during runtime. In some instances, the AV software 160A may determine that some restrictions are incompatible with each other, and assign suitable priorities to the restrictions.

In 422, the user 102A may request an operation to be performed by the AV, and AV software 160A receives such request.

In 424, the AV software 160A may check the configuration to determine whether the operation is allowed or restricted by the configuration.

In 426, if the configuration does not allow the operation, the AV software 160A may notify user 102A.

Method for Respecting Restrictions on a Software Release for Deployment on One or More Processors of an Autonomous Vehicle

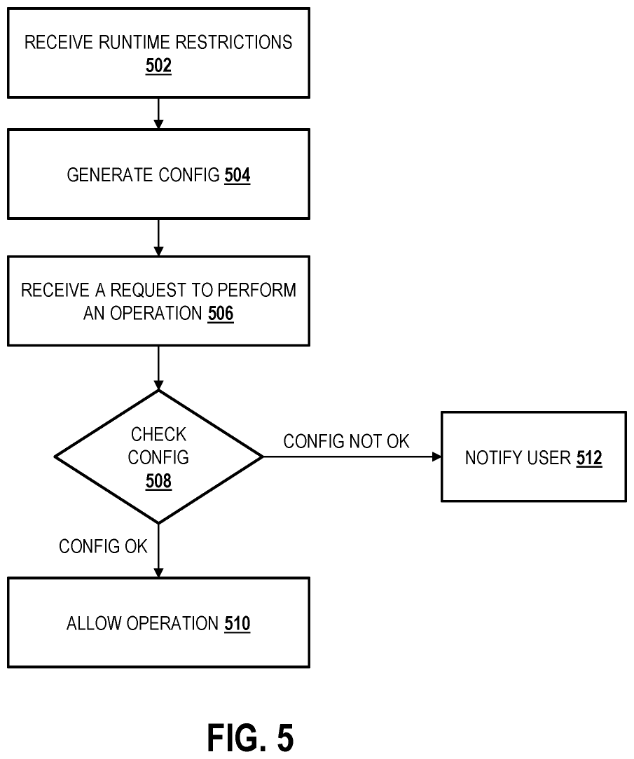

FIG. 5 is a flow diagram illustrating a computer-implemented method for respecting restrictions on a software release for deployment on one or more processors of an autonomous vehicle, according to some aspects of the disclosed technology.

In 502, one or more runtime restrictions may be received. The one or more runtime restrictions can be extracted from a cryptographically signed manifest that references artifacts of the software release.

In 504, configuration can be generated based on the one or more runtime restrictions.

In 506, a request to perform an operation of the autonomous vehicle can be received while the software release is running on the autonomous vehicle.

In 508, the configuration can be checked to determine whether the operation is allowed by the configuration.

In 510, the operation of the autonomous vehicle can be allowed to be performed if the configuration allows the operation.

In 512, a user can be notified if the configuration does not allow the operation.

Exemplary AV Management System

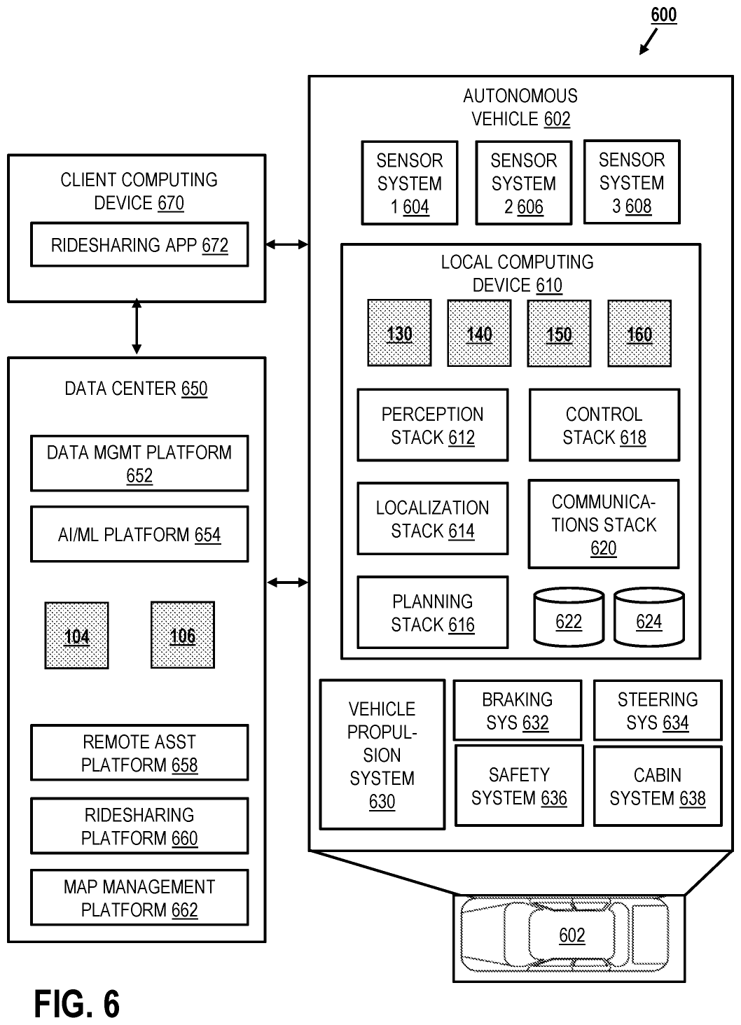

Turning now to FIG. 6, this figure illustrates an example of an AV management system 600, in which some of the aspects of the present disclosure can be implemented. One of ordinary skill in the art will understand that, for the AV management system 600 and any system discussed in the present disclosure, there may be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 600 includes an AV 602, a data center 650, and a client computing device 670. The AV 602, the data center 650, and the client computing device 670 may communicate with one another over one or more networks (not shown), such as a public network (e.g., the Internet, an Infrastructure as a Service (IaaS) network, a Platform as a Service (PaaS) network, a Software as a Service (SaaS) network, another Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 602 may navigate about roadways without a human driver based on sensor signals generated by multiple sensor systems 604, 606, and 608. The sensor systems 604-708 may include different types of sensors and may be arranged about the AV 602. For instance, the sensor systems 604-608 may comprise Inertial Measurement Units (IMUs), cameras (e.g., still image cameras, video cameras, etc.), light sensors (e.g., LIDAR systems, ambient light sensors, infrared sensors, etc.), RADAR systems, a Global Navigation Satellite System (GNSS) receiver, (e.g., Global Positioning System (GPS) receivers), audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 604 may be a camera system, the sensor system 606 may be a LIDAR system, and the sensor system 608 may be a RADAR system. Other embodiments may include any other number and type of sensors.

AV 602 may also include several mechanical systems that may be used to maneuver or operate AV 602. For instance, the mechanical systems may include vehicle propulsion system 630, braking system 632, steering system 634, safety system 636, and cabin system 638, among other systems. Vehicle propulsion system 630 may include an electric motor, an internal combustion engine, or both. The braking system 632 may include an engine brake, a wheel braking system (e.g., a disc braking system that utilizes brake pads), hydraulics, actuators, and/or any other suitable componentry configured to assist in decelerating AV 602. The steering system 634 may include suitable componentry configured to control the direction of movement of the AV 602 during navigation. Safety system 636 may include lights and signal indicators, a parking brake, airbags, and so forth. The cabin system 638 may include cabin temperature control systems, in-cabin entertainment systems, and so forth. In some embodiments, the AV 602 may not include human driver actuators (e.g., steering wheel, handbrake, foot brake pedal, foot accelerator pedal, turn signal lever, window wipers, etc.) for controlling the AV 602. Instead, the cabin system 638 may include one or more client interfaces (e.g., GUIs, Voice User Interfaces (VUIs), etc.) for controlling certain aspects of the mechanical systems 630-638.

AV 602 may additionally include a local computing device 610 that is in communication with the sensor systems 604-608, the mechanical systems 630-638, the data center 650, and the client computing device 670, among other systems. The local computing device 610 may include one or more processors and memory, including instructions that may be executed by the one or more processors. The instructions may make up one or more software stacks or components responsible for controlling the AV 602; communicating with the data center 650, the client computing device 670, and other systems; receiving inputs from riders, passengers, and other entities within the AV's environment; logging metrics collected by the sensor systems 604-608; and so forth. In this example, the local computing device 610 includes a perception stack 612, a mapping and localization stack 614, a planning stack 616, a control stack 618, a communications stack 620, an HD geospatial database 622, and an AV operational database 624, among other stacks and systems. Additionally, to support deployment of software releases and enforcement of restrictions on AV 602, components 130, 140, 150, and/or 160 as illustrated in FIGS. 1 and 4 may be implemented on local computing device 1010.

Perception stack 612 may enable the AV 602 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 604-608, the mapping and localization stack 614, the HD geospatial database 622, other components of the AV, and other data sources (e.g., the data center 650, the client computing device 670, third-party data sources, etc.). The perception stack 612 may detect and classify objects and determine their current and predicted locations, speeds, directions, and the like. In addition, the perception stack 612 may determine the free space around the AV 602 (e.g., to maintain a safe distance from other objects, change lanes, park the AV, etc.). The perception stack 612 may also identify environmental uncertainties, such as where to look for moving objects, flag areas that may be obscured or blocked from view, and so forth.

Mapping and localization stack 614 may determine the AV's position and orientation (pose) using different methods from multiple systems (e.g., GPS, IMUs, cameras, LIDAR, RADAR, ultrasonic sensors, the HD geospatial database 622, etc.). For example, in some embodiments, the AV 602 may compare sensor data captured in real-time by the sensor systems 604-608 to data in the HD geospatial database 622 to determine its precise (e.g., accurate to the order of a few centimeters or less) position and orientation. The AV 602 may focus its search based on sensor data from one or more first sensor systems (e.g., GPS) by matching sensor data from one or more second sensor systems (e.g., LIDAR). If the mapping and localization information from one system is unavailable, the AV 602 may use mapping and localization information from a redundant system and/or from remote data sources.

The planning stack 616 may determine how to maneuver or operate the AV 602 safely and efficiently in its environment. For example, the planning stack 616 may receive the location, speed, and direction of the AV 602, geospatial data, data regarding objects sharing the road with the AV 602 (e.g., pedestrians, bicycles, vehicles, ambulances, buses, cable cars, trains, traffic lights, lanes, road markings, etc.) or certain events occurring during a trip (e.g., an Emergency Vehicle (EMV) blaring a siren, intersections, occluded areas, street closures for construction or street repairs, DPVs, etc.), traffic rules and other safety standards or practices for the road, user input, and other relevant data for directing the AV 602 from one point to another. The planning stack 616 may determine multiple sets of one or more mechanical operations that the AV 602 may perform (e.g., go straight at a specified speed or rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 616 may select from multiple backup plans to carry out. For example, while preparing to change lanes to turn right at an intersection, another vehicle may aggressively cut into the destination lane, making the lane change unsafe. The planning stack 616 could have already determined an alternative plan for such an event, and upon its occurrence, help to direct the AV 602 to go around the block instead of blocking a current lane while waiting for an opening to change lanes.

The control stack 618 may manage the operation of the vehicle propulsion system 630, the braking system 632, the steering system 634, the safety system 636, and the cabin system 638. The control stack 618 may receive sensor signals from the sensor systems 604-608 as well as communicate with other stacks or components of the local computing device 610 or a remote system (e.g., the data center 650) to effectuate operation of the AV 602. For example, the control stack 618 may implement the final path or actions from the multiple paths or actions provided by the planning stack 616. Implementation may involve turning the routes and decisions from the planning stack 616 into commands for the actuators that control the AV's steering, throttle, brake, and drive unit.

The communication stack 620 may transmit and receive signals between the various stacks and other components of the AV 602 and between the AV 602, the data center 650, the client computing device 670, and other remote systems. The communication stack 620 may enable the local computing device 610 to exchange information remotely over a network. The communication stack 620 may also facilitate local exchange of information, such as through a wired connection or a local wireless connection.

The HD geospatial database 622 may store HD maps and related data of the streets upon which the AV 602 travels. In some embodiments, the HD maps and related data may comprise multiple layers, such as an areas layer, a lanes and boundaries layer, an intersections layer, a traffic controls layer, and so forth. The areas layer may include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer may include geospatial information of road lanes (e.g., lane or road centerline, lane boundaries, type of lane boundaries, etc.) and related attributes (e.g., direction of travel, speed limit, lane type, etc.). The lanes and boundaries layer may also include 3D attributes related to lanes (e.g., slope, elevation, curvature, etc.). The intersections layer may include geospatial information of intersections (e.g., crosswalks, stop lines, turning lane centerlines, and/or boundaries, etc.) and related attributes (e.g., permissive, protected/permissive, or protected only left-turn lanes; permissive, protected/permissive, or protected only U-turn lanes; permissive or protected only right-turn lanes; etc.). The traffic controls layer may include geospatial information of traffic signal lights, traffic signs, and other road objects and related attributes.

The AV operational database 624 may store raw AV data generated by the sensor systems 604-708 and other components of the AV 602 and/or data received by the AV 602 from remote systems (e.g., the data center 650, the client computing device 670, etc.). In some embodiments, the raw AV data may include HD LIDAR point cloud data, image or video data, RADAR data, GPS data, and other sensor data that the data center 650 may use for creating or updating AV geospatial data as discussed further below with respect to FIG. 5 and elsewhere in the present disclosure.

The data center 650 may be a private cloud (e.g., an enterprise network, a co-location provider network, etc.), a public cloud (e.g., an IaaS network, a PaaS network, a SaaS network, or other CSP network), a hybrid cloud, a multi-cloud, and so forth. The data center 650 may include one or more computing devices remote to the local computing device 610 for managing a fleet of AVs and AV-related services. For example, in addition to managing the AV 602, the data center 650 may also support a ridesharing service, a delivery service, a remote/roadside assistance service, street services (e.g., street mapping, street patrol, street cleaning, street metering, parking reservation, etc.), and the like.

The data center 650 may send and receive various signals to and from the AV 602 and the client computing device 670. These signals may include sensor data captured by the sensor systems 604-608, roadside assistance requests, software updates, ridesharing pick-up and drop-off instructions, and so forth. In this example, the data center 650 includes one or more of a data management platform 652, an Artificial Intelligence/Machine Learning (AI/ML) platform 654, a simulation platform 656, a remote assistance platform 658, a ridesharing platform 660, and a map management platform 662, among other systems.

Data management platform 652 may be a “big data” system capable of receiving and transmitting data at high speeds (e.g., near real-time or real-time), processing a large variety of data, and storing large volumes of data (e.g., terabytes, petabytes, or more of data). The varieties of data may include data having different structures (e.g., structured, semi-structured, unstructured, etc.), data of different types (e.g., sensor data, mechanical system data, ridesharing service data, map data, audio data, video data, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 650 may access data stored by the data management platform 652 to provide their respective services.

The AI/ML platform 654 may provide the infrastructure for training and evaluating machine learning algorithms for operating the AV 602, the simulation platform 656, the remote assistance platform 658, the ridesharing platform 660, the map management platform 662, and other platforms and systems. Using the AI/ML platform 654, data scientists may prepare data sets from the data management platform 652; select, design, and train machine learning models; evaluate, refine, and deploy the models; maintain, monitor, and retrain the models; and so on.

Components 104 and/or 106 of FIG. 1 may be implemented in data center 650.

The remote assistance platform 658 may generate and transmit instructions regarding the operation of the AV 602. For example, in response to an output of the AI/ML platform 654 or other system of the data center 650, the remote assistance platform 658 may prepare instructions for one or more stacks or other components of the AV 602.

The ridesharing platform 660 may interact with a customer of a ridesharing service via a ridesharing application 672 executing on the client computing device 670. The client computing device 670 may be any type of computing system, including a server, desktop computer, laptop, tablet, smartphone, smart wearable device (e.g., smart watch; smart eyeglasses or other Head-Mounted Display (HMD); smart ear pods or other smart in-ear, on-ear, or over-ear device; etc.), gaming system, or other general-purpose computing device for accessing the ridesharing application 672. The client computing device 670 may be a customer's mobile computing device or a computing device integrated with the AV 602 (e.g., the local computing device 610). The ridesharing platform 660 may receive requests to be picked up or dropped off from the ridesharing application 672 and dispatch the AV 602 for the trip.

Map management platform 662 may provide a set of tools for the manipulation and management of geographic and spatial (geospatial) and related attribute data. The data management platform 652 may receive LIDAR point cloud data, image data (e.g., still image, video, etc.), RADAR data, GPS data, and other sensor data (e.g., raw data) from one or more AVs 602, Unmanned Aerial Vehicles (UAVs), satellites, third-party mapping services, and other sources of geospatially referenced data. The raw data may be processed, and map management platform 662 may render base representations (e.g., tiles (2D), bounding volumes (3D), etc.) of the AV geospatial data to enable users to view, query, label, edit, and otherwise interact with the data. Map management platform 662 may manage workflows and tasks for operating on the AV geospatial data. Map management platform 662 may control access to the AV geospatial data, including granting or limiting access to the AV geospatial data based on user-based, role-based, group-based, task-based, and other attribute-based access control mechanisms. Map management platform 662 may provide version control for the AV geospatial data, such as to track specific changes that (human or machine) map editors have made to the data and to revert changes when necessary. Map management platform 662 may administer release management of the AV geospatial data, including distributing suitable iterations of the data to different users, computing devices, AVs, and other consumers of HD maps. Map management platform 662 may provide analytics regarding the AV geospatial data and related data, such as to generate insights relating to the throughput and quality of mapping tasks.

In some embodiments, the map viewing services of map management platform 662 may be modularized and deployed as part of one or more of the platforms and systems of the data center 650. For example, the AI/ML platform 654 may incorporate the map viewing services for visualizing the effectiveness of various object detection or object classification models, the simulation platform 656 may incorporate the map viewing services for recreating and visualizing certain driving scenarios, the remote assistance platform 658 may incorporate the map viewing services for replaying traffic incidents to facilitate and coordinate aid, the ridesharing platform 660 may incorporate the map viewing services into the client application 672 to enable passengers to view the AV 602 in transit enroute to a pick-up or drop-off location, and so on.

Exemplary Processor-Based System

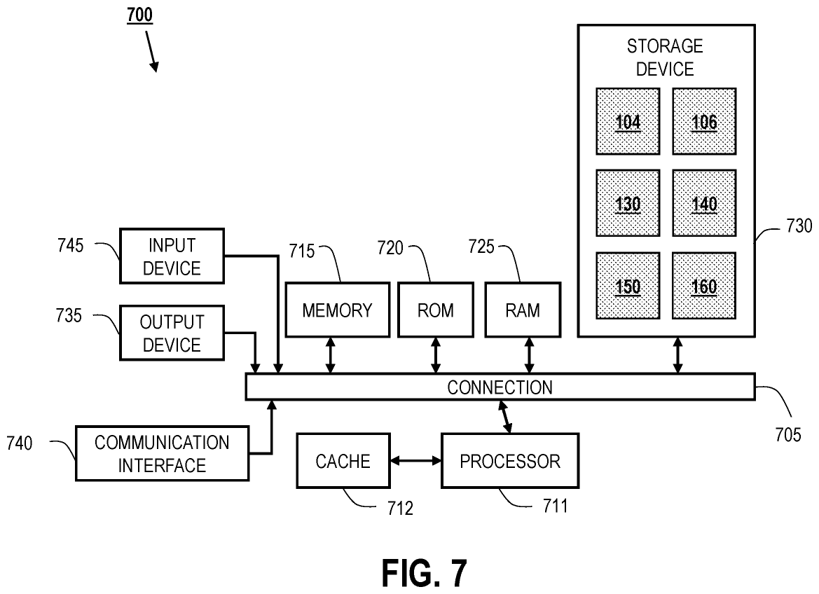

FIG. 7 illustrates an example processor-based system with which some aspects of the subject technology may be implemented. For example, processor-based system 700 may be any computing device making up, or any component thereof in which the components of the system are in communication with each other using connection 705. Connection 705 may be a physical connection via a bus, or a direct connection into processor 710, such as in a chipset architecture. Connection 705 may also be a virtual connection, networked connection, or logical connection.

In some embodiments, computing system 700 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 700 includes at least one processing unit (Central Processing Unit (CPU) or processor) 710 and connection 705 that couples various system components including system memory 715, such as Read-Only Memory (ROM) 720 and Random-Access Memory (RAM) 725 to processor 710. Computing system 700 may include a cache of high-speed memory 712 connected directly with, in close proximity to, or integrated as part of processor 710.

Processor 710 may include any general-purpose processor and a hardware service or software service, implementing functionalities carried out by components 104, 106, 130, 140, and 150, and 160 as illustrated in FIGS. 1 and 4. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which may represent any number of input mechanisms, such as a microphone for speech, a touch-sensitive screen for gesture or graphical input, keyboard, mouse, motion input, speech, etc. Computing system 700 may also include output device 735, which may be one or more of a number of output mechanisms known to those of skill in the art. In some instances, multimodal systems may enable a user to provide multiple types of input/output to communicate with computing system 700. Computing system 700 may include communications interface 740, which may generally govern and manage the user input and system output. The communication interface may perform or facilitate receipt and/or transmission wired or wireless communications via wired and/or wireless transceivers.

Communication interface 740 may also include one or more GNSS receivers or transceivers that are used to determine a location of the computing system 700 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 may be a non-volatile and/or non-transitory and/or computer-readable memory device and may be a hard disk or other types of computer-readable media which may store data that are accessible by a computer.

Storage device 730 may include software services, servers, services, etc., that when the code that defines such software is executed by the processor 710, it causes the system 700 to perform a function. In some embodiments, a hardware service that performs a particular function may include the software component stored in a computer-readable medium in connection with the necessary hardware components, such as processor 710, connection 705, output device 735, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices may be any available device that may be accessed by a general-purpose or special-purpose computer, including the functional design of any special-purpose processor as described above. By way of example, and not limitation, such tangible computer-readable devices may include RAM, ROM, EEPROM, CD-ROM or other optical disk storage, magnetic disk storage or other magnetic storage devices, or any other device which may be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special-purpose computer, or special-purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network personal computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

### Select Examples

Example 1 is a computer-implemented method for respecting restrictions on a software release for deployment on one or more processors of an autonomous vehicle, the method comprising: receiving one or more runtime restrictions, wherein the one or more runtime restrictions are extracted from a cryptographically signed manifest that references artifacts of the software release; generating configuration based on the one or more runtime restrictions; receiving a request to perform an operation of the autonomous vehicle, while the software release is running on the autonomous vehicle; checking the configuration to determine whether the operation is allowed by the configuration; allowing the operation of the autonomous vehicle to be performed if the configuration allows the operation; and notifying a user if the configuration does not allow the operation.

In Example 2, the method of Example 1 can optionally include the operation being related to engaging in driverless operation.

In Example 3, the method of Example 1 or 2 can optionally include the operation comprising entering a new operational design domain.

In Example 4, the method of any one of Examples 1-3 can optionally include the operation comprising crossing a perimeter of a geofence.

In Example 5, the method of any one of Examples 1-4 can optionally include the operation comprising performing a driving maneuver.

In Example 6, the method of any one of Examples 1-5 can optionally include the operation comprising accepting a new operational assignment for the autonomous vehicle, wherein the new operational assignment comprises a trip to a destination.

In Example 7, the method of any one of Examples 1-6 can optionally include: the one or more runtime restrictions comprising a restriction to ensure that the software release is only deployed on a certain type of autonomous vehicle stack; and the method further comprising causing the autonomous vehicle to launch the certain type autonomous vehicle stack before launching the software release.

In Example 8, the method of Example 7 can optionally include the certain type of autonomous vehicle stack being a limited-purpose calibration stack.

In Example 9, the method of Example 7 can optionally include the certain type of autonomous vehicle stack being an on-road autonomous vehicle stack.

In Example 10, the method of any one of Examples 1-9 can optionally include: receiving a restriction specifying an authorized vehicle identification number, wherein the restriction is extracted from the cryptographically signed manifest; and verifying whether a vehicle identification number of the autonomous vehicle matches the authorized vehicle identification number.

In Example 11, the method of Example 10 can optionally include: if the vehicle identification number of the autonomous vehicle matches the authorized vehicle identification number, deploying the software release on the autonomous vehicle; and otherwise (if the vehicle identification number of the autonomous vehicle does not match the authorized vehicle identification number, preventing the software release from being deployed on the autonomous vehicle.

In Example 12, the method of any one of Examples 1-11 can optionally include: receiving a restriction specifying an authorized fleet, wherein the restriction is extracted from the cryptographically signed manifest; determining a fleet to which the autonomous vehicle belongs; and verifying whether the fleet matches the authorized fleet.

In Example 13, the method of Example 12 can optionally include: if the fleet matches the authorized fleet, deploying the software release on the autonomous vehicle; and otherwise (if the fleet does not match the authorized fleet), preventing the software release from being deployed on the autonomous vehicle.

In Example 14, the method of any one of Examples 1-13 can optionally include: receiving a restriction specifying a not-before time before which deployment of the software release is not allowed, wherein the restriction is extracted from the cryptographically signed manifest; and verifying whether a current time is before the not-before time.

In Example 15, the method of Example 14 can optionally include: if the current time is before the not-before time, preventing the software release from being deployed on the autonomous vehicle.

In Example 16, the method of any one of Examples 1-15 can optionally include: receiving a restriction specifying a not-after time after which deployment of the software release is not allowed, wherein the restriction is extracted from the cryptographically signed manifest; and verifying whether a current time is after the not-after time.

In Example 17, the method of Example 16 can optionally include: if the current time is after the not-after time, preventing the software release from being deployed on the autonomous vehicle.

In Example 18, the method of any one of Examples 1-17 can optionally include: receiving a restriction specifying a period of time during which deployment of the software release is allowed, wherein the restriction is extracted from the cryptographically signed manifest; and verifying whether a current time is within the period of time.

In Example 19, the method of Example 18 can optionally include: if the current time is not within the period of time, preventing the software release from being deployed on the autonomous vehicle.

In Example 20, the method of any one of Examples 1-19 can optionally include: receiving one or more static restrictions, wherein the one or more static restrictions are extracted from a cryptographically signed manifest.

In Example 21, the method of any one of Examples 1-20 can optionally include: receiving one or more launch-time restrictions, wherein the one or more launch-time restrictions are extracted from a cryptographically signed manifest.

In Example 22, the method of any one of Examples 1-21 can optionally include: the one or more restrictions having corresponding one or more priorities.

In Example 23, the method of any one of Examples 1-22 can optionally include: the one or more restrictions being arranged in a logical hierarchy of restrictions.

Example 24 is a computer-implemented method for respecting restrictions on a software release for deployment on one or more processors of an autonomous vehicle, the method comprising: receiving a plurality of restrictions, wherein the restrictions are extracted from a cryptographically signed manifest that references artifacts of the software release; verifying a first subset of restrictions before deploying artifacts of the software release on an autonomous vehicle; generating a configuration based on a second subset of restrictions; and verifying one or more operations of the autonomous vehicle during runtime of the software release against the configuration before performing the one or more operations.

In Example 25, the method of Example 24 can optionally include: verifying a third subset of restrictions before launching an autonomous vehicle stack on the autonomous vehicle and launching the software release on the autonomous vehicle stack.

In Example 26, the method of Example 24 or 25 can optionally include features in any one of Examples 2-23.

Example 27 is a computer-implemented method for extracting restrictions on a software release for deployment on one or more processors of an autonomous vehicle, comprising: receiving a cryptographically signed manifest of a software release, wherein the cryptographically signed manifest includes: hash digest of each artifacts; and one or more restrictions; verifying the cryptographically signed manifest; retrieve artifacts; verifying a first subset of restrictions before deploying artifacts of the software release on an autonomous vehicle; and if the first subset of restrictions are met and the artifacts of the software release are deployed on the autonomous vehicle: generating a configuration based on a second subset of restrictions; and verifying one or more operations of the autonomous vehicle during runtime of the software release against the configuration before performing the one or more operations.

In Example 28, the method of Example 27 can optionally include: if the first subset of restrictions are met, verifying a third subset of restrictions before launching an autonomous vehicle stack on the autonomous vehicle and launching the software release on the autonomous vehicle stack.

In Example 29, the method of Example 27 or 28 can optionally include features in any one of Examples 2-23.

Example 30 is a computer-implemented system, comprising: one or more processing units; one or more non-transitory computer-readable media storing instructions, when executed by the one or more processing units, cause the one or more processing units to perform operations comprising operations of any one of the methods in Examples 1-29.

Example 31 is one or more non-transitory computer-readable media storing instructions, when executed by the one or more processing units, cause the one or more processing units to perform operations comprising operations of any one of the methods in Examples 1-29.

Example 32 is an apparatus comprising means for performing any one of the methods in Examples 1-29.

Example 26 is an autonomous vehicle having components to implement and perform any one of the methods in Examples 1-29.

1. A computer-implemented method for respecting restrictions on a software release for deployment on one or more processors of an autonomous vehicle, the method comprising:
receiving one or more runtime restrictions, wherein the one or more runtime restrictions are extracted from a cryptographically signed manifest that references artifacts of the software release;
generating configuration based on the one or more runtime restrictions;
receiving a request to perform an operation of the autonomous vehicle, while the software release is running on the autonomous vehicle;
checking the configuration to determine whether the operation is allowed by the configuration;
allowing the operation of the autonomous vehicle to be performed if the configuration allows the operation; and
notifying a user if the configuration does not allow the operation.

2. The method of claim 1, wherein the operation is related to engaging in driverless operation.

3. The method of claim 1, wherein the operation comprises one or more of the following:
entering a new operational design domain;
crossing a perimeter of a geofence;
performing a driving maneuver; and
accepting a new operational assignment for the autonomous vehicle, wherein the new operational assignment comprises a trip to a destination.

4. The method of claim 1, wherein:
the one or more runtime restrictions comprise a restriction to ensure that the software release is only deployed on a certain type of autonomous vehicle stack; and
the method further comprises causing the autonomous vehicle to launch the certain type autonomous vehicle stack before launching the software release.

5. The method of claim 1, further comprising:
receiving a restriction specifying an authorized vehicle identification number, wherein the restriction is extracted from the cryptographically signed manifest; and
verifying whether a vehicle identification number of the autonomous vehicle matches the authorized vehicle identification number.

6. The method of claim 5, further comprising:
if the vehicle identification number of the autonomous vehicle matches the authorized vehicle identification number, deploying the software release on the autonomous vehicle; and
if the vehicle identification number of the autonomous vehicle does not match the authorized vehicle identification number, preventing the software release from being deployed on the autonomous vehicle.

7. The method of claim 1, further comprising:
receiving a restriction specifying an authorized fleet, wherein the restriction is extracted from the cryptographically signed manifest;
determining a fleet to which the autonomous vehicle belongs; and
verifying whether the fleet matches the authorized fleet.

8. The method of claim 7, further comprising:
if the fleet matches the authorized fleet, deploying the software release on the autonomous vehicle; and
if the fleet does not match the authorized fleet, preventing the software release from being deployed on the autonomous vehicle.

9. The method of claim 1, further comprising:
receiving a restriction specifying a not-before time before which deployment of the software release is not allowed, wherein the restriction is extracted from the cryptographically signed manifest; and
verifying whether a current time is before the not-before time.

10. The method of claim 9, further comprising:
if the current time is before the not-before time, preventing the software release from being deployed on the autonomous vehicle.

11. The method of claim 1, further comprising:
receiving a restriction specifying a not-after time after which deployment of the software release is not allowed, wherein the restriction is extracted from the cryptographically signed manifest; and
verifying whether a current time is after the not-after time.

12. The method of claim 11, further comprising:
if the current time is after the not-after time, preventing the software release from being deployed on the autonomous vehicle.

13. The method of claim 1, further comprising:
receiving a restriction specifying a period of time during which deployment of the software release is allowed, wherein the restriction is extracted from the cryptographically signed manifest; and
verifying whether a current time is within the period of time.

14. The method of claim 13, further comprising:
if the current time is not within the period of time, preventing the software release from being deployed on the autonomous vehicle.

15. A computer-implemented method for respecting restrictions on a software release for deployment on one or more processors of an autonomous vehicle, the method comprising:
receiving a plurality of restrictions, wherein the restrictions are extracted from a cryptographically signed manifest that references artifacts of the software release;
verifying a first subset of restrictions before deploying artifacts of the software release on an autonomous vehicle;
generating a configuration based on a second subset of restrictions; and
verifying one or more operations of the autonomous vehicle during runtime of the software release against the configuration before performing the one or more operations.

16. The method of claim 15, further comprising:
verifying a third subset of restrictions before launching an autonomous vehicle stack on the autonomous vehicle and launching the software release on the autonomous vehicle stack.

17. The method of claim 15, wherein the one or more operations are related to engaging in driverless operation.

18. The method of claim 15, wherein the one or more operations comprise one or more of the following:
entering a new operational design domain;
crossing a perimeter of a geofence;
performing a driving maneuver; and
accepting a new operational assignment for the autonomous vehicle, wherein the new operational assignment comprises a trip to a destination.

19. A computer-implemented method for extracting restrictions on a software release for deployment on one or more processors of an autonomous vehicle, comprising:
receiving a cryptographically signed manifest of a software release, wherein the cryptographically signed manifest includes:
hash digest of each artifacts; and
one or more restrictions;
verifying the cryptographically signed manifest;
retrieve artifacts;
verifying a first subset of restrictions before deploying artifacts of the software release on an autonomous vehicle; and
if the first subset of restrictions are met and the artifacts of the software release are deployed on the autonomous vehicle:
generating a configuration based on a second subset of restrictions; and
verifying one or more operations of the autonomous vehicle during runtime of the software release against the configuration before performing the one or more operations.

20. The method of claim 19, further comprising:
if the first subset of restrictions are met, verifying a third subset of restrictions before launching an autonomous vehicle stack on the autonomous vehicle and launching the software release on the autonomous vehicle stack.
